(19) United States
(12) Patent Application Publication
(10) Pub. No.: US 2021/0037183 A1
(43) Pub. Date: Feb. 4, 2021

(54) MONOCENTRIC MULTISCALE (MMS) CAMERA HAVING ENHANCED FIELD OF VIEW

(71) Applicants: Aqueti Incorporated, Durham, NC (US); Duke University, Durham, NC (US)

(72) Inventors: Wubin PANG, Durham, NC (US); David Jones BRADY, Durham, NC (US)

(21) Appl. No.: 16/964,130

(22) PCT Filed: Feb. 15, 2019
(86) PCT No.: PCT/US2019/018199

§ 371 Date: Jul. 22, 2020

Related U.S. Application Data
(60) Provisional application No. 62/631,170, filed on Feb. 15, 2018.

(51) Int. Cl. H04N 5/232; G02B 13/06; G02B 7/02

(52) U.S. Cl. CPC H04N 5/23238; G02B 7/026; G02B 13/06

(57) ABSTRACT

Disclosed are various arrangements of monocentric multiscale imaging systems and cameras that advantageously exhibit an enhanced field of view (FoV). Illustrative examples of such systems include a 360° ring FoV MMS lens that advantageously captures approximately 500-mega-pixel image from a circular ring area. Additionally, by varying microcamera imaging channel configurations, we disclose a multi-focal design that advantageously can range from 15 mm to 40 mm providing coverage of a scene with widely different imaging magnifications. Finally, additional illustrative configurations combine multiple MMS systems such that an arbitrary solid angle in 4π space is covered.

### CROSS REFERENCE TO RELATED APPLICATIONS

This application claims the benefit of U.S. Provisional Application Ser. No. 62/631,170 filed 15 Feb. 2018 the entire contents of which is incorporated by reference as if set forth at length herein.

### TECHNICAL FIELD

This disclosure relates generally to optics and digital imaging and, more particularly, to large-pixel-count imaging systems including monocentric multiscale cameras having an enhanced field of view.

### BACKGROUND

As will be readily appreciated by those skilled in the art, digital imaging systems, methods, and structures are employed in an ever-increasing number of applications and have become integral in every industry imaginable—making, creating, storing, analyzing, and disseminating images.

Given this importance, improved systems, methods, and structures for digital imaging—and in particular—systems, methods and structures which facilitate the development of large-pixel-count imaging (i.e., gigapixel)—would represent a welcome addition to the art.

### SUMMARY

An advance is made in the art according to aspects of the present disclosure directed to systems, methods, and structures for monocentric multiscale imaging systems and cameras having an enhanced field of view as compared with the prior art.

In sharp contrast to the prior art arrangements of monocentric multiscale imaging systems and cameras according to the present disclosure provide—illustratively—a 360° ring FoV MMS lens that advantageously captures approximately 500-mega-pixel image from a circular ring area. Additionally, by varying microcamera imaging channel configurations, we disclose a multi-focal design that advantageously can range from 15 mm to 40 mm providing coverage of a scene with widely different imaging magnifications. Finally, additional illustrative configurations combine multiple MMS systems such that an arbitrary solid angle in 4π space is covered

This SUMMARY is provided to briefly identify some aspect(s) of the present disclosure that are further described below in the DESCRIPTION. This SUMMARY is not intended to identify key or essential features of the present disclosure nor is it intended to limit the scope of any claims.

The term “aspect” is to be read as “at least one aspect”. The aspects described above and other aspects of the present disclosure are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 shows a schematic diagram illustrating hexagonal close-packing for a localized FoV output according to an aspect of the present disclosure;

FIG. 2 shows an illustrative close-packing of 492 circles on a spherical surface using a distorted icosahedral deodesic method according to aspects of the present disclosure;

FIG. 3 shows an illustrative diagram of an obscuration occurring when two microcameras are positioned in each other's light path according to aspects of the present disclosure;

FIGS. 4(A) and 4(B) show the calculation of maximum packing angle cFov in which: FIG. 4(A) illustrates a light path of one channel in an MMS lens; while FIG. 4(B) illustrates a maximum packing angle given specified design parameters according to aspects of the present disclosure;

FIGS. 5(A), 5(B), and 5(C) show schematic diagrams of illustrative MMS optical imaging systems with ring FoV in which: FIG. 5(A) shows an MMS camera on a pole with a FoV of a ring area while FIG. 5(B) shows an 165 circles packed on a belt on a top hemisphere with polar angle ranging from 43° to 76° while FIG. 5(C) shows an illustrative layout of an MMS lens design—according to the present disclosure;

FIGS. 6(A) and 6(B) show illustrative imaging performance of a 360 ring MMS lens in which: FIG. 6(A) shows an illustrative layout of one channel of 360 ring Fov MMS lens design while FIG. 6(B) shows an illustrative MTF curves according to an aspect of the present disclosure;

FIGS. 7(A), 7(B), and 7(C) show schematic diagrams of an illustrative multifocal system in which: FIG. 7(A) illustrates monitoring traffic along a street from one end, while FIG. 7(B) shows illustrative multiple imaging channels of optics employed, and FIG. 7(B) shows an optical layout of a multifocal system according to an aspect of the present disclosure;

FIGS. 8(A), 8(B), and 8(C) show plots of MTF curves of each channel in multifocal MMS lens design for: FIG. 8(A) MTFs of on-axis FoV; FIG. 8(B) shows MTFs of 0.707 FoV and FIG. 8(C) shows MTFs of marginal FoV—according to an aspect of the present disclosure;

FIGS. 9(A) and 9(B) show illustrative approaches to 360° horizontal FoV optics including: FIG. 9(A) shows an illustrative layout including three back-to-back MMS lenses and FIG. 9(B) showing an illustrative interleaving strategy with MMS lenses stacked—according to an aspect of the present disclosure;

FIG. 10 shows illustrative microcameras and light window(s) of 360° horizontal FOV imager according to aspects of the present disclosure;

FIGS. 11(A) and 11(B) show illustrative tetrahedral geometry of full spherical MMS lens in which: FIG. 11(A) shows illustrative space segmentation with four MMS lenses with each one covering a quarter of the full sphere; and FIG. 11(B) showing illustratively close-packed microcameras on one of the four segments—according to an aspect of the present disclosure;

FIG. 12 shows illustrative layout view of a full spherical MMS lens according to aspects of the present disclosure;

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that certain methods according to the present disclosure may represent various processes which may be substantially represented in computer readable medium and so controlled and/or executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

By way of some additional background, we begin by noting that the demand for gigapixel-scale cameras and imaging systems has been steadily increasing given their recognized utility in a variety of applications including broadcast media, imaging, virtual reality, flight control, transportation management, security, and environmental monitoring,—among others. Notwithstanding this considerable demand, utilization of such gigapixel systems has been tempered due—in part—to the cost and system complexity of such gigapixel systems coupled with recognized computational and communications challenge(s) of gigapixel image management.

Given these infirmities, the art has directed considerable enthusiasm towards Monocentric Multiscale (MMS) imaging systems and cameras that may advantageously reduce the cost and complexity of gigapixel imaging systems due to several design and technology breakthroughs. Notably, and as will be readily appreciated by those skilled in the art, MMS imaging systems and cameras advantageously achieve both high angular resolution and a wide field of view (FOV) in gigapixel scale systems. In contrast with gigapixel astronomical telescopes and lithographic lenses, MMS imaging systems and cameras according to the present disclosure may advantageously be manufactured and assembled using commercially available, off-the-shelf components and methods, while the former may only can be realized in precisely controlled lab environment with purposely developed tools and materials.

We note that the architecture of an illustrative MMS system generally resembles that of a telescope. More particularly, one layered monocentric spherical objective lens is shared by several microcameras, wherein each microcamera covers a portion of an overall FOV—denoted as microcamera FOV (MFOV). We note further that refractive telescopes may be classified into Keplerian systems having an internal image surface and Galilean systems having secondary optics positioned before an objective focal surface. Yet while MMS systems may be designed according to either of these two classifications, and that Galilean systems achieve a smaller physical size, prior art MMS imaging systems and cameras all adopt Keplerian design(s) because such architectures more readily accommodate overlap between adjacent microcamera FOV and because they are easier to construct.

As will be understood and appreciated by those skilled in the art, field of view (FoV) and instantaneous field of view (iFoV) are two basic measures of camera performance. Conventionally, FoV describes the angular extent of a cone around the optical axis observed by a camera. As is known, fisheye lenses have long been used to achieve wide field of view imaging. For example, the Ricoh Theta and the Samsung Gear 360 capture 360°×180° images. Despite such impressive FoV, distortion and aberration in fisheye systems severely limits iFoV. For at least this reason, systems that capture a wide field of view by computationally stitching images obtained using temporal scanning or camera arrays have become increasingly popular. Note that higher resolution full solid angle imaging has been implemented in camera arrays like as the Facebook Surround 360.

Several platforms have recently been developed that generalize 360 camera design to include more diverse parallel camera architectures. While a camera array can be designed to cover any FoV and iFoV, the cost of such systems increases nonlinearly as iFoV decreases. One fundamental issue is that as iFoV decreases entrance aperture must increase. Those skilled in the art will readily understand that lens cost increases nonlinearly with entrance aperture size and such cost is raised still further if FoV per microlens decreases as required by conventional scaling—since the number of microlenses required to fill a given field of view must then also increase as iFoV decreases.

In sharp contrast, multiscale designs in which a parallel array of microcameras share a common objective lens, have been shown to allow wide FoV over a wide range of aperture scales. Monocentric multiscale (MMS) designs using a spherical objective lens and microcameras mounted on a spherical shell have been particularly effective in this regard.

While previous works by the instant applicants has primarily focused on multiscale design for lens systems with a conventional, cone-shaped FoV, this disclosure describes novel MMS designs suitable for wide angle applications commonly associated with fish-eye lenses and ring-shaped camera arrays.

At this point we note that focus control presents a considerable challenge for conventional wide field imaging systems. More particularly, even if a fish-eye lens can reasonably focus on a scene in one configuration, the design of such lenses for focal accommodation is extremely challenging. And while we do not explicitly discuss focal accommodation in this disclosure, we note that the ability to independently and locally control focus state in each microcamera of an MMS system is a particular advantage of such MMS systems. Notwithstanding, we recognize the significance of work relating to focus control strategies and note that these strategies can be implemented in the systems disclosed herein. We now show how spherical geometry of MMS systems allows a variety of novel field of view alignments according to aspects of the present disclosure.

By way of illustrative example, we note that security cameras are oftentimes installed on a ceiling or pole overlooking a target field of view. Complementing such installations, contemporary systems oftentimes incorporate mechanical pan-tilt-zoom components that allow a camera to scan wide angle fields with high resolution.

Alternatively, such security camera systems may combine a wide-angle spotting camera with a long focal length narrow field slew camera. In operation, when an event of interest is registered by the wide-angle camera, the long focal length narrow field slew camera will be directed into that event and capture high resolution details.

As those skilled in the art will readily appreciate however, there are at least three disadvantages to such camera system configurations. First, only one region of the full field is captured in high resolution. Second, the response time and mechanical motion speed may be limited and unable to keep up with rapidly changing events—especially when several events take place simultaneously. Third, mechanical components may render the entire system unreliable and afflicted with high maintenance cost.

In sharp contrast, MMS achieve a wide field and a high resolution in real time. With such an architecture, parallel small aperture optics outperforms the traditional single aperture lens thereby providing a significantly improved information efficiency. In addition, the MMS' shared objective lens results in a more compact layout as compared with that of multi-camera clusters. Since MIMS imaging sensors are tessellated over a spherical surface—as long as there is no notable inter-occlusion occurring—a target from any spatial angle can be imaged by a microcamera appropriately configured.

Those skilled in the art will know and appreciate that there are numerous ways of arranging a microcamera array hence the configurations of the FoV. This flexibility offers great opportunities for different FoV configurations and other camera set ups for various application scenarios. In addition to arrangement flexibility of one MMS lens, more configurations can be realized by using multiple MMS lenses as a combination.

As an illustrative example, we have previously described a design for compact wide field imaging using three MMS systems. In this disclosure, we now disclose and describe enhancements to our designs to include compact 360 ring cameras, multifocal length/extended depth of field systems and full sphere imaging systems. We note however, that the illustrative designs presented herein are intended as simple illustrations of the potential of systems constructed according to the present disclosure while—in practice—systems can be constructed which cover an arbitrary field of view and depth of field.

As will be readily understood by those skilled in the art, conventional cameras capture images in a rectangular format due to the format of film, electronic sensor and display devices. In most cases, the captured FoV is slated to be fully streamed for rendering, e.g. the FoV shape/format of any captured image data is determined by the rendering convention employed.

As technologies in optics, electronics and computation advance however, this close coupling between image capturing and rendering needs to be decoupled to further exploit image information and further creation of novel functionalities. We note that an arbitrary image format realizable by synthesizing image frames derived from multiple focal planes. Additionally, as new image and video rendering technologies are explored and subsequently developed, alternative image navigation methods will become readily available for development of new ways of rendering.

As will be further understood and appreciated by those skilled in the art, an MMS lens expands its FOV by adding up small size secondaries. The resulting, ultra-high information capacity advantageously allows for a myriad of FoV configuration options and image resolution formats, which provides widespread applicability to new and different application scenarios.

As will be known and appreciated by those skilled in the art—with systems including an MMS architecture, the microcameras are packed or otherwise positioned on a spherical surface. Accordingly, the extent and format of the FoV captured are determined by the manner of packing the microcameras. And while such positioning/packing is a relatively trivial task in case of a 2D plane, close-packing on a spherical surface can be much more challenging.

We note that depending on the extent of a targeted packing region, either a local packing or a global packing strategy is preferable. A local packing strategy is preferred if the packing region comprises only a small fraction of the whole sphere onto which the microcameras are to be positioned.

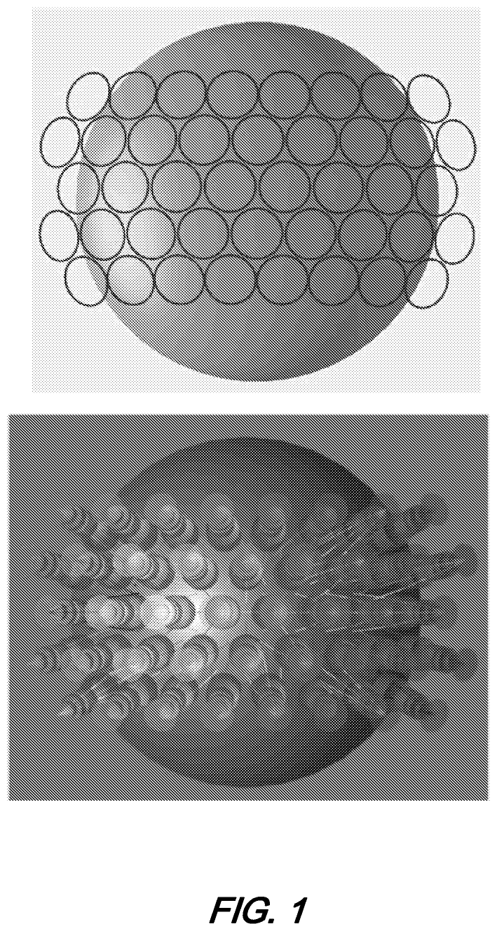

Turning our attention now to FIG. 1, there is shown a schematic diagram illustrating hexagonal close-packing for a localized FoV output according to an aspect of the present disclosure. As illustratively shown in this figure, the packing region covers approximately 90°×50° FoV, and with the hexagonal close-packing employed, the microcameras are aligned along lines of latitude. This packing method produces a near rectangular FoV coverage resembling a conventional image format that produces a cord ratio defined by the following:

$$Chord Ratio = \frac{\begin{matrix}Maximum Circle Separation - \\ Minimum Circle Separation\end{matrix}}{Minimum Circle Separation} \qquad [ 1 ]$$

As a matter of experience, a chord ratio value less than 0.17 creates small perturbation and uniform packing density which leads to a high image quality and reduced lens complexity. Observing this rule of thumb, a hexagonal packing strategy can only achieve a maximum latitudinal angle span of 60°.

We note that additional previous work has implemented a packing strategy based on a distorted icosahedral geodesic. By iteratively subdividing a regular icosahedron that is projected onto a sphere, this strategy produces an approximately uniformly distributed grid of circles on the whole globe.

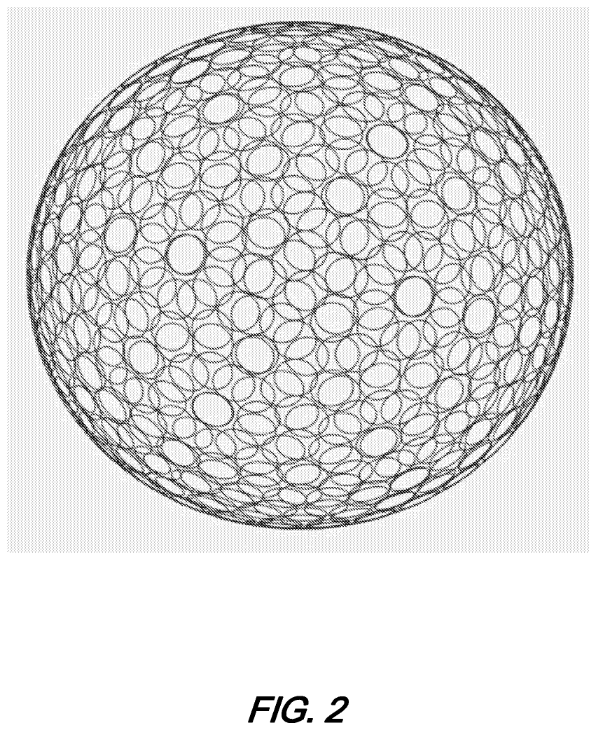

FIG. 2 shows an illustrative close-packing of 492 circles on a spherical surface using a distorted icosahedral deodesic method (strategy) according to aspects of the present disclosure Even with such an extensive global packing method, the full extent of the packing area is nevertheless limited as light paths from different channels may interfere with each other.

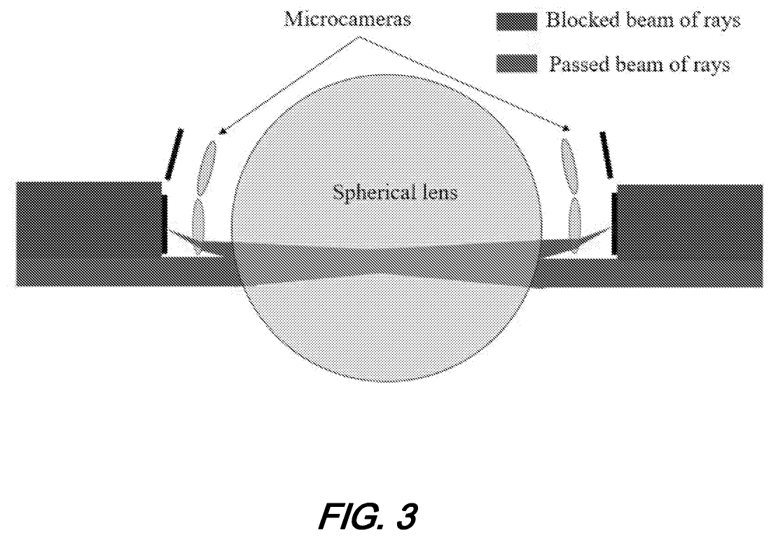

FIG. 3 shows an illustrative diagram of an obscuration occurring when two microcameras are positioned in each other's light path according to aspects of the present disclosure. As may be observed from that FIG. 3, when close-packed regions expand to approximately 180°, the light paths are interfered by sensors located on opposite side(s) of the globe i.e., spherical lens. Of course, the maximum packing angle is also dependent upon specifications of the optical system employed.

At this point we may now estimate a maximum angle cFoV within which a light path stays obscuration free. We note that a MMS lens of Galilean style exhibits the following parameters: the focal length of the spherical objective lens is fₒ, the radius of the objective is R, the distance between the stop and the center of the objective is dₒₛ, the distance between entrance pupil and the center of the objective is l_{ε}, the half FoV angle of each sub-imager is α.

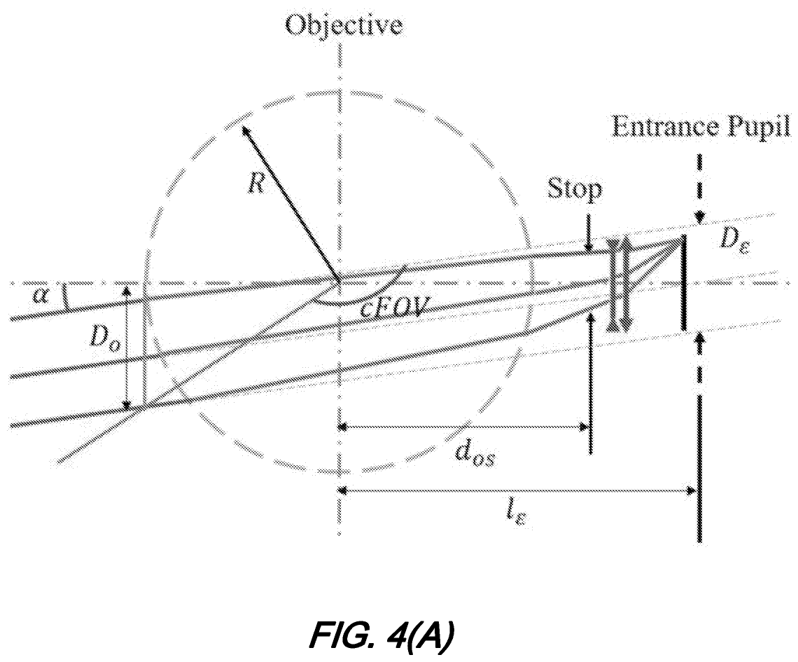

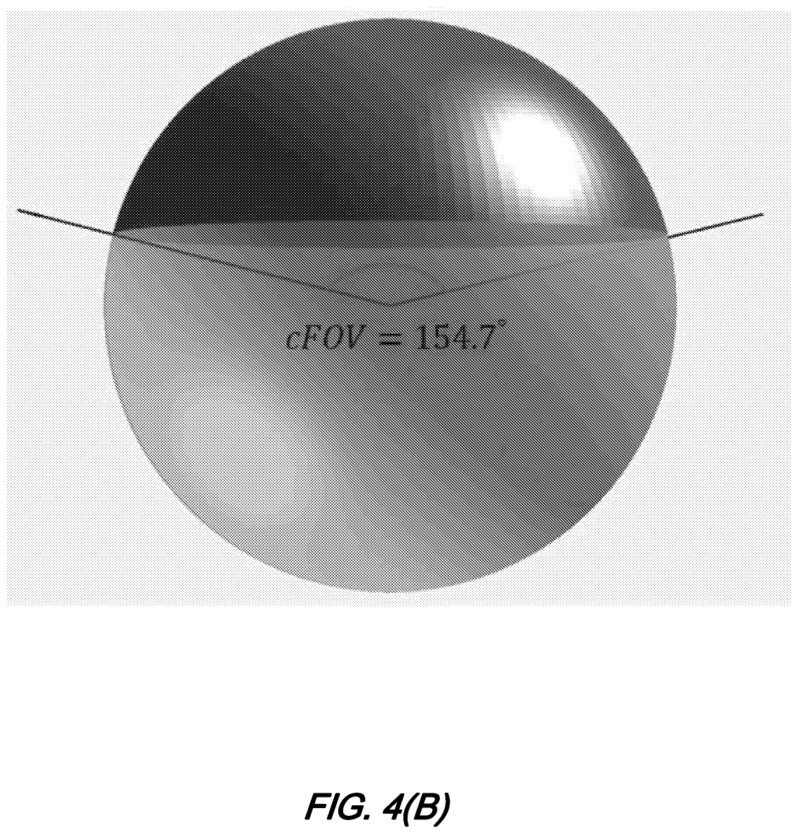

FIGS. 4(A) and 4(B) show the calculation of maximum packing angle cFov in which: FIG. 4(A) illustrates a light path of one channel in an MMS lens; while FIG. 4(B) illustrates a maximum packing angle given specified design parameters according to aspects of the present disclosure.

As depicted in FIG. 4(A), an imaging channel is located on the margin of a multi-channel MMS system. The line which connects the entrance point of the marginal ray with the center of the objective lens serves as another margin of this multi-channel system. If all the channels are confined by the cone included by these two margins, this system is obscuration free.

The clear semi-diameter of the objective can be approximated as:

$${D}_{O} = ( {l}_{ɛ} + R ) α + \frac{{D}_{ɛ}}{2} = ( \frac{{f}_{O} {d}_{OS}}{{f}_{O} - {d}_{OS}} + R ) α + \frac{f}{2 F / \#} \qquad [ 2 ]$$

where f is the overall effective focal length.

The free angle cFoV can be determined from the following relationship:

$$cFoV = α + π - arctan ( \frac{{D}_{O}}{R} ) \qquad [ 3 ]$$

Assuming an illustrative design wherein chief parameters are: f=20 mm, F/#=2.5, f₀=47.06, R=21.11 mm, dₒₛ=27.49 mm, α=5.7 and substituting these parameters into EQN.(2) and EQN.(3), we have a clear angle of FoV, namely cFoV=77.35°.

FIG. 4(B) shows this free packing cap as the top portion of the sphere illustrated therein. As we shall now describe, this set of design specifications will be used to show an illustrative configuration with a ring-shaped FoV.

We note—and as will be readily appreciated by those skilled in the art—numerous contemporary applications benefit from cameras with a ring-shaped field of view—such as used for security purposes in parks, squares, traffic circles and entry/exit ways, where the top and bottom views with content are not of concern. 360° ring FoV cameras are developed to increase situational awareness in surveillance, navigation applications and in Virtual Reality (VR) and Augmented Reality (AR) for stereo effect [19]. 360° photography is also called panoramic imaging. A common way of doing panoramic imaging is by tiling multiple cameras in a circle. As mentioned previously, this method usually ends up with bulky and costly hardware. The rest of the section shows how MMS architecture deal with this subject with superior dexterity.

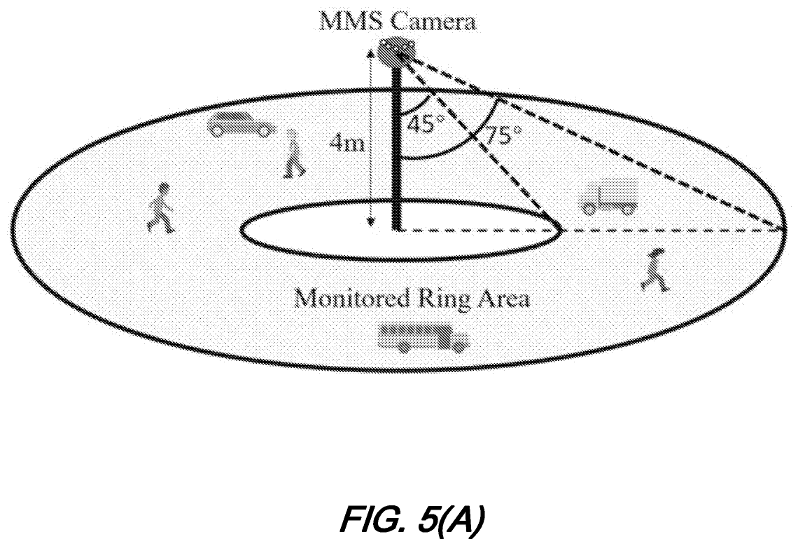

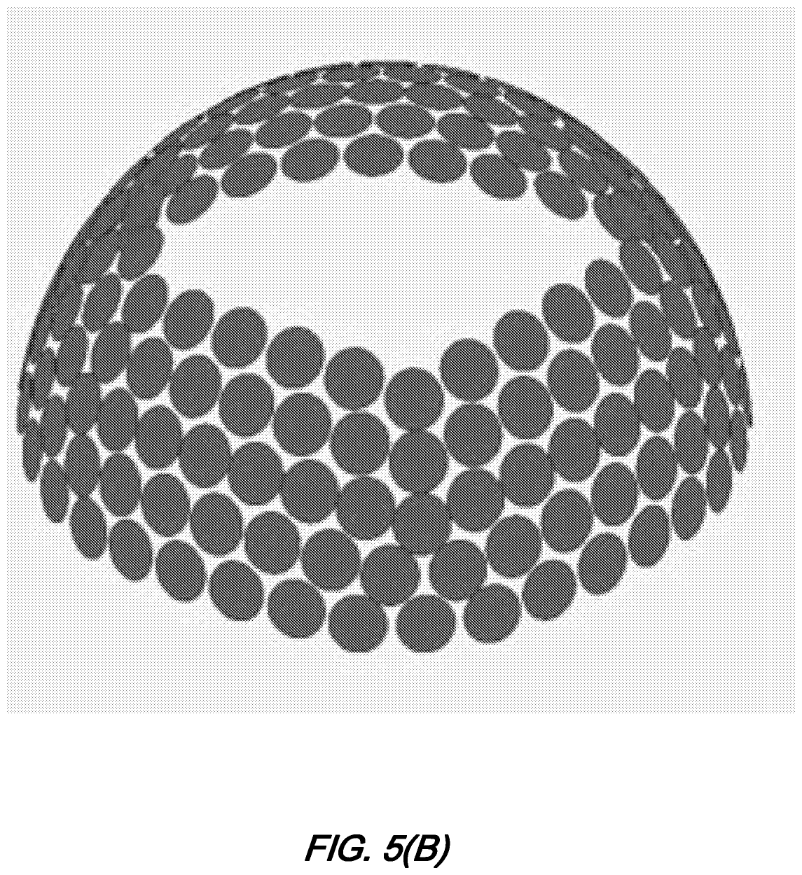

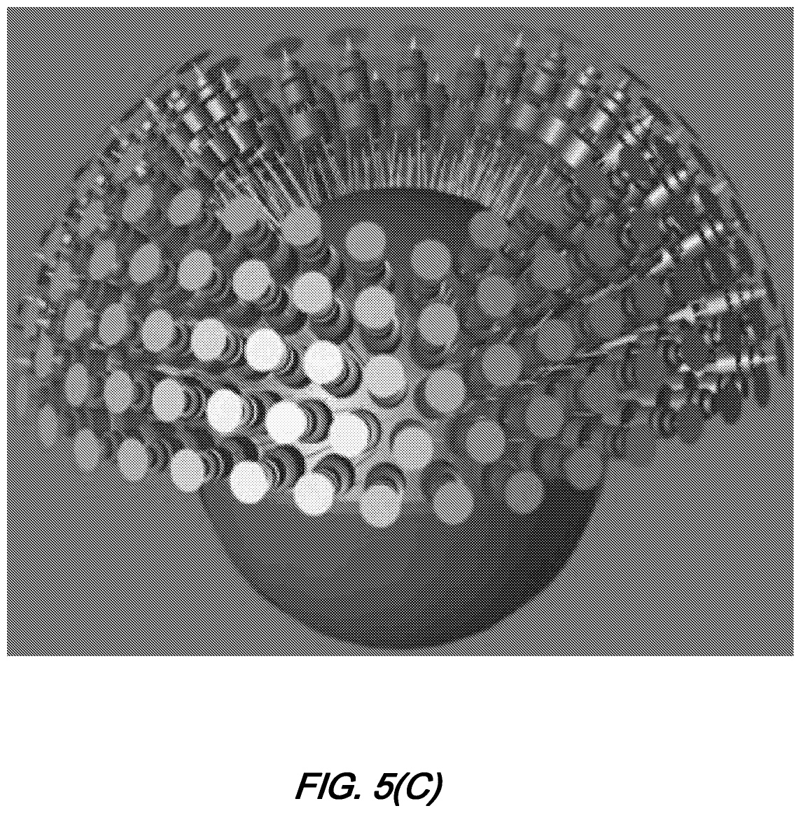

FIGS. 5(A), 5(B), and 5(C) show schematic diagrams of illustrative MMS optical imaging systems with ring FoV in which: FIG. 5(A) shows an MMS camera on a pole with a FoV of a ring area while FIG. 5(B) shows an 165 circles packed on a belt on a top hemisphere with polar angle ranging from 43° to 76° while FIG. 5(C) shows an illustrative layout of an MMS lens design—according to the present disclosure.

As illustrated in FIG. 5(A), consider an arrangement wherein a camera is installed on the top end of a pole which is 4 m above the ground. The view angle (the angle formed by the upright pole and the dotted lines) of the camera is 45° when aiming at the inner boarder and 75° when at the outer boarder. By simple calculation, the radius of the inner border is 4 m while the radius of the outer border is about 14.93 m. The distance between the inner circle and the camera is about 5.67 m and that of the outer circle is about 15.45 m.

A square image sensor chip would be ideal for MMS lens design for its advantage in producing a mosaic. The effective focal length f is chosen to be 20 mm, which is adequate for the required angular resolution. The aperture size is F/#=2.5 and the FoV of each sub-imager (microcamera) is 11.4°.

Since the monitored area covers an extensive area of the hemisphere, a local packing method would lead to an inferior quality in terms of packing uniformity. Here we configure our MMS lens by choosing a group of circle slots that resulted from the distorted icosahedron geodesic method shown previously in FIG. 2. The corresponding slots with microcameras are highlighted by patches in FIG. 5(B) and in FIG. 5(C) shows the layout of the corresponding optical design.

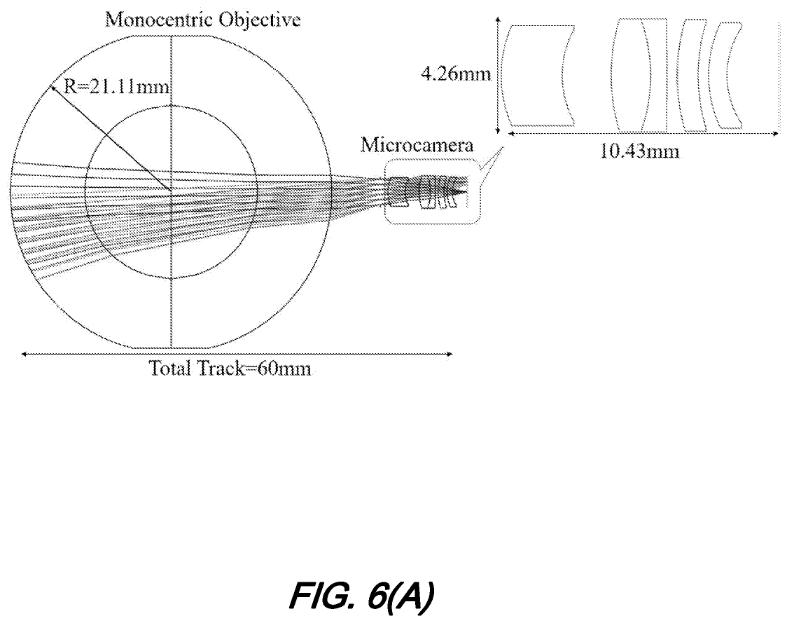

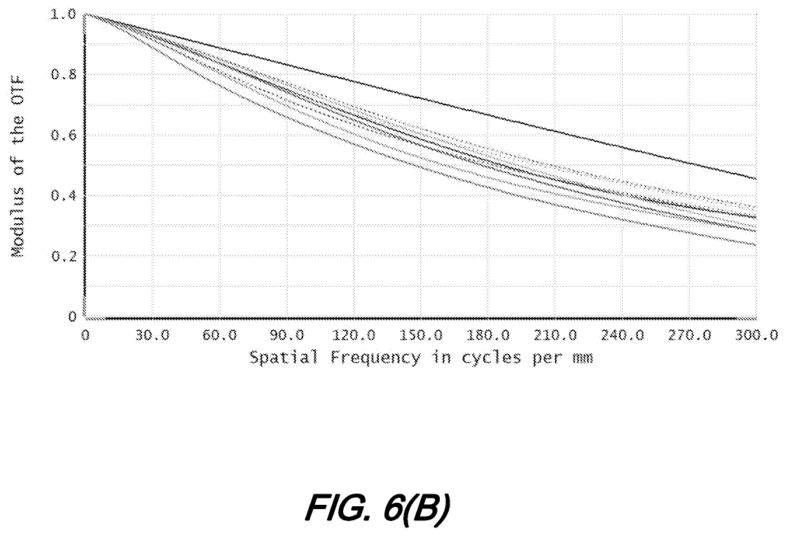

FIGS. 6(A) and 6(B) show illustrative imaging performance of a 360 ring MMS lens in which: FIG. 6(A) shows an illustrative layout of one channel of 360 ring Fov MMS lens design while FIG. 6(B) shows an illustrative MTF curves according to an aspect of the present disclosure.

With reference to these figures, we note that another optical design now disclosed includes 165 microcameras covering a polar angle from 43° to 76°. The covered FoV is not exactly equal to the required due to discretely added FoV with step of 11.4° of each channel.

FIG. 6(A) shows the dimension of one channel of the optics. The spherical ball lens has a radius of 21.11 mm and the total track of optics is 60 mm. The image area of each focal plane is 2.8 mm×2.8 mm, the resolvable pixel pitch which can be estimated by MTF curves shown in FIG. 6(B) is about 1.67 μm, therefore, the resolution elements of each focal plane is about 2.8 mega-pixel. The total resolution elements is approximately 500 Mpixel.

As will be understood by those skilled in the art, for a single focal length camera, magnification varies for objects at different ranges. The further the object from the camera, the smaller the magnification. As will be appreciated, this property may cause difficulty in recognition of objects dispersed over a deep depth of field.

One solution to this problem is to employ a zoom lens. Such a zoom lens adjusts (zooms) to a long focal length for distant objects and to a short focal length for close objects. Another alternative solution employs a camera cluster that includes multiple cameras exhibiting different focal lengths wherein cameras exhibiting a long focal length employed for distant objects and cameras exhibiting a short(er) focal length for close(r) objects.

As compared with these two techniques, an MMS lens architecture provides a more compact, more modular and less expensive way of conducting multi-focal imaging. In a MMS lens architecture, the overall effective focal length of any individual channel can be varied by changing its design of secondary optics. By applying different secondary optics, we can advantageously integrate multiple focal lengths within a single optical system.

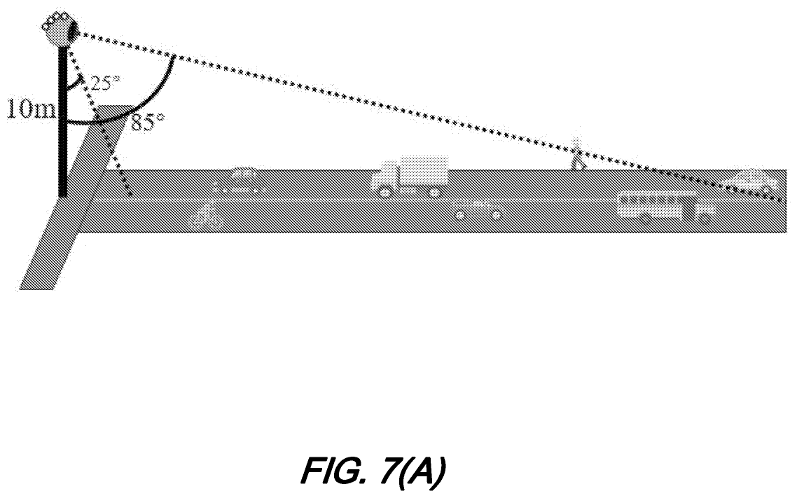

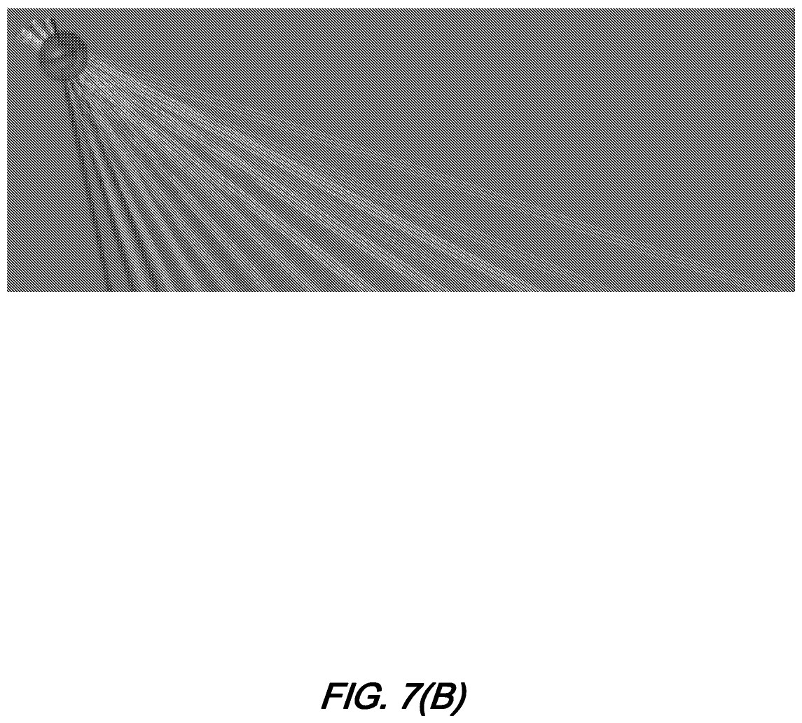

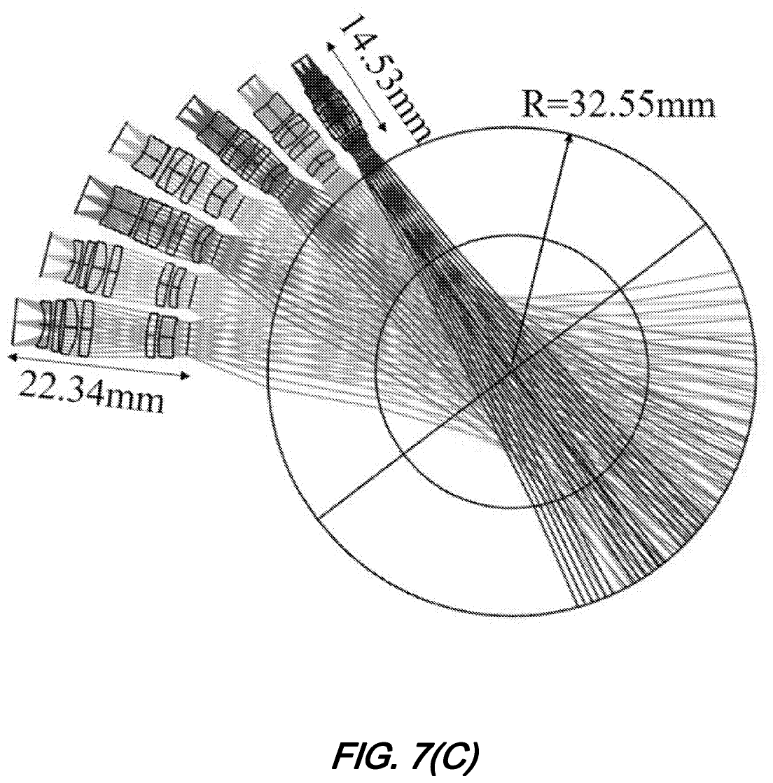

FIG. 7(A), FIGS. 7(A), 7(B), and 7(C) show schematic diagrams of an illustrative multifocal system in which: FIG. 7(A) illustrates monitoring traffic along a street from one end, while FIG. 7(B) shows illustrative multiple imaging channels of optics employed, and FIG. 7(B) shows an optical layout of a multifocal system according to an aspect of the present disclosure.

FIG. 7(A) shows illustratively an arrangement for supervising a stretched street from one end of the street, wherein the object plane is a narrow, tilted strip that results in large, object-range-variance as measured from the camera's perspective. In such illustrative arrangement, the viewing angle ranges from 25° to 85°. To capture detailed information over this entire strip, a multifocal system is advantageously employed.

FIG. 7(B) shows an illustrative MMS lens covering different street segments with channels of varying focal lengths. As the segment moves away from the camera, the respective channel increases in its focal length for a more uniform ground sampling.

Those skilled in the art will understand and appreciate that it is impossible to achieve a uniform sampling with a finite segmentation of the field of view. However, we can attempt to obtain a nominally uniform sampling with a multifocal imager having equal magnification in the axial field point of each channel. In this illustrative example, we may install the camera 10 m above the ground with each channel covering a 10° area and 1.5° overlap between adjacent channels. With 7 channels, the total range of the surveillance is about 110 m. The focal lengths of each channel and the respective object distances of central field of view are tabulated in Table. 1.

TABLE 1
Axial object range of each imaging channel
for a quasi-uniform sampling rate

| Channel# | 1 | 2 | 3 | 4 | 5 | 6 | 7 |
|---|---|---|---|---|---|---|---|
| Viewing | 30.0 | 38.5 | 47.0 | 55.5 | 64.0 | 72.5 | 81.0 |
| angle (deg) | | | | | | | |
| Axial object | 11.55 | 12.78 | 14.66 | 17.66 | 22.81 | 33.26 | 63.92 |
| range (m) | | | | | | | |
| Focal | 15.00 | 16.38 | 18.48 | 21.71 | 27.00 | 36.73 | 59.39 |
| length (mm) | | | | | | | |

With continued reference to this figure—and as shown in Table 1—a uniform sampling rate over the entire street requires a focal range from 15 mm to 59.39 mm which requires a 4× zoom capacity. Unfortunately, however, our illustrative MMS design only achieves a focal range from 15 mm to 40 mm. As a result, the 7th channel cannot satisfy a quasi-uniform condition. Notwithstanding, a varying sensor pitch can be employed to compensate for this.

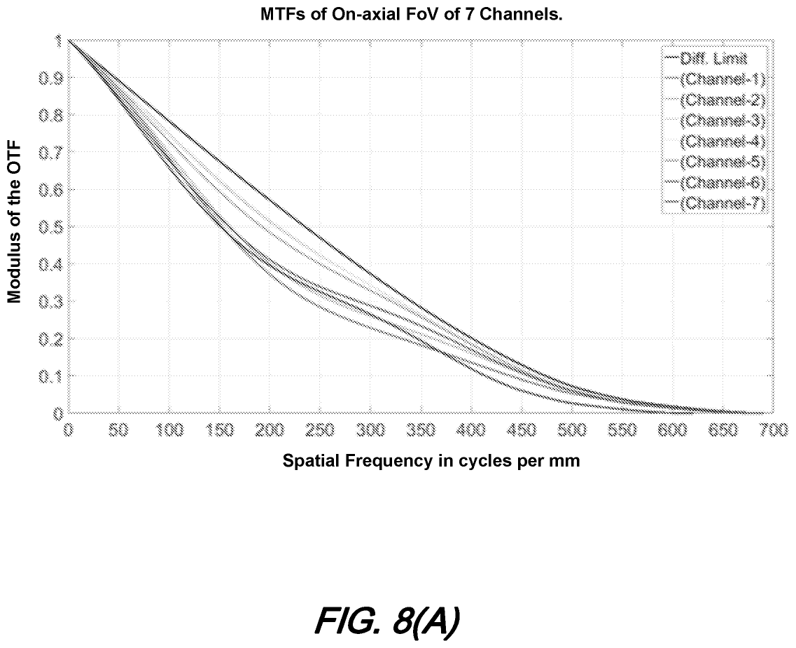

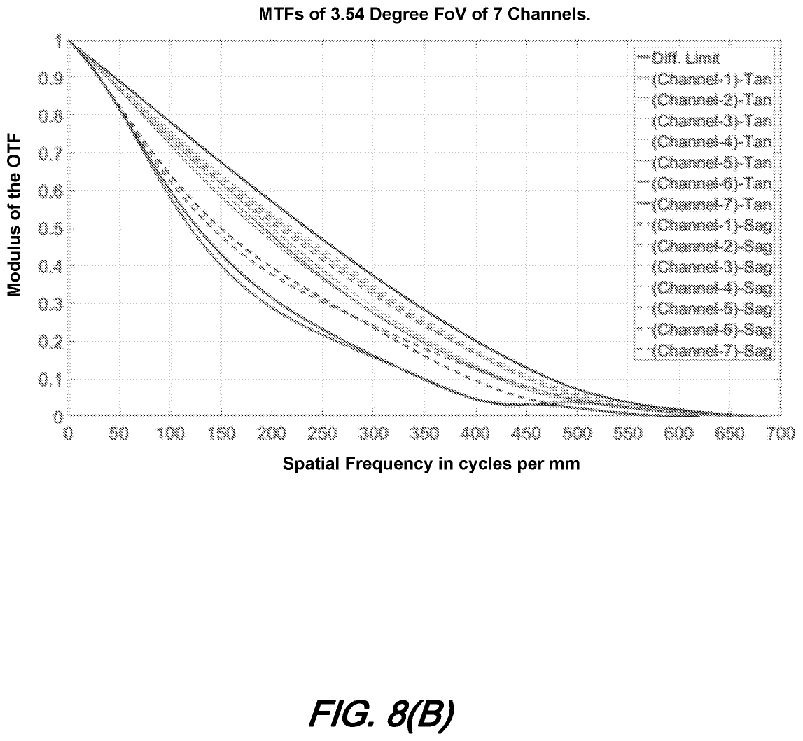

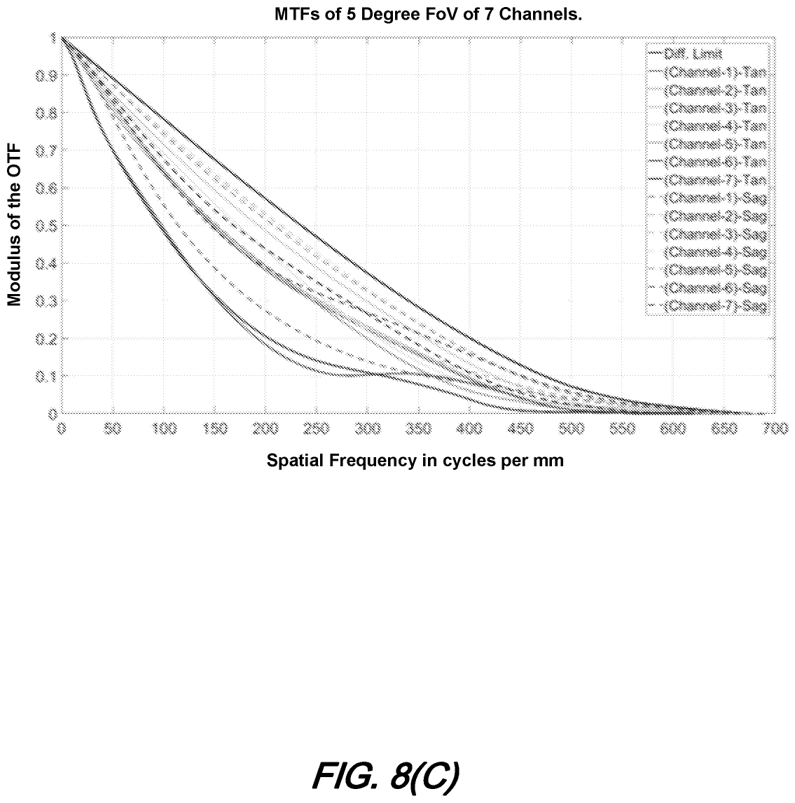

FIG. 7(C) shows an illustrative layout of such a lens design and size(s) of some critical dimensions. The MTF curves for each channel are shown in FIG. 8. For a given primary objective lens, there is a mostly matched system focal length at which optimal imaging performance is achieved. However, the performance degrades mildly as the focal length deviates from the optimally matched.

FIGS. 8(A), 8(B), and 8(C) show plots of MTF curves of each channel in multifocal MMS lens design for: FIG. 8(A) MTFs of on-axis FoV; FIG. 8(B) shows MTFs exhibiting a 0.707 FoV and FIG. 8(C) shows MTFs having a marginal FoV—according to an aspect of the present disclosure. As may be observed from these figures, channel 4 exhibits highest MTF for both on-axis and off-axis FoVs while a satisfactory performance can be obtained as the focal length scales on either side with a zoom ratio about 2.7×. Detailed design prescription data is available in Table S2.

As discussed previously, light path obscuration prevents arbitrary FoV configuration for one MMS camera. Nonetheless, this limitation can be surmounted by a combinational use of multiple MMS cameras. One such example that has been demonstrated is where multiple MMS lenses are co-boresighted to interleave a continuous coverage of a wide FoV. Here we disclose yet another example.

With respect to the 360° ring FoV lens described previously, we note that the viewing angle ranges from 4° to 76°. However, light occlusion occurs when the covering area approaches the equator as shown illustratively in FIG. 3.

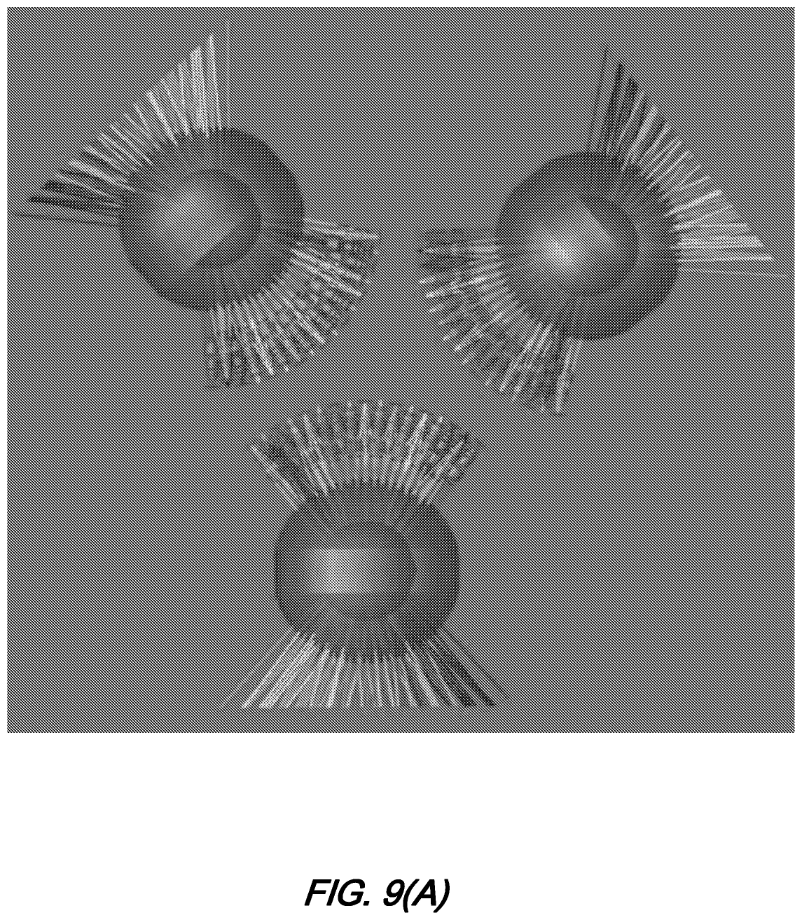

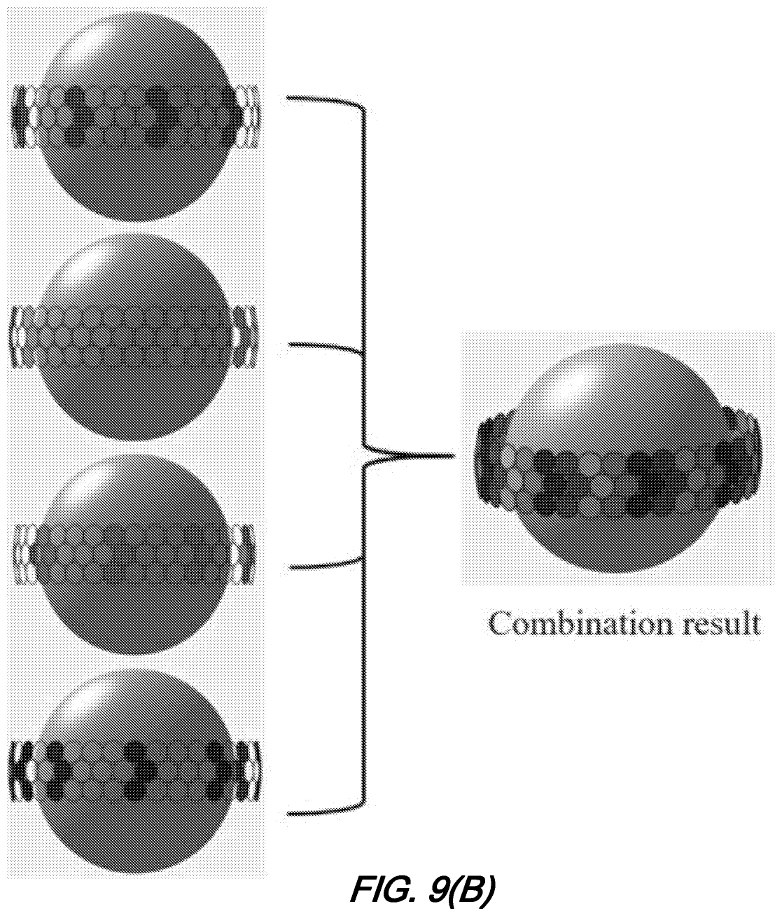

FIGS. 9(A) and 9(B) show illustrative approaches to 360° horizontal FoV optics including: FIG. 9(A) shows an illustrative layout including three back-to-back MMS lenses and FIG. 9(B) showing an illustrative interleaving strategy with MMS lenses stacked—according to an aspect of the present disclosure.

As illustrated in FIG. 9(A), one solution according to aspects of the present disclosure is characterized by configuring three MMS lens positioned back to back with each one covering a FoV larger than 120°. Collectively, a 360° panoramic image in horizontal direction is captured without occlusion.

Another configuration according to aspects of the present disclosure provides a spherical camera where free spaces are reserved between adjacent optic and sensors for light to pass through. To achieve this field of view using a multiscale array, some microcamera positions are saved for light passages. For a continuous FoV coverage, we combine image patches captured by multiple MMS cameras together.

Turning our attention now to FIG. 9(B), shown illustratively therein are four MMS lenses stacked vertically and interleaved for complete coverage of 360° horizontal FoV. In a most simple configuration, all four of the MMS cameras are identical, only being twisted relatively for staggered angular positions. The cone angle of each small circle here is 10°, the number of circles along one orbit of the sphere is 36. While we have indicated that all four cameras are identical, those skilled in the art will know and appreciate that such identicality is not a necessity.

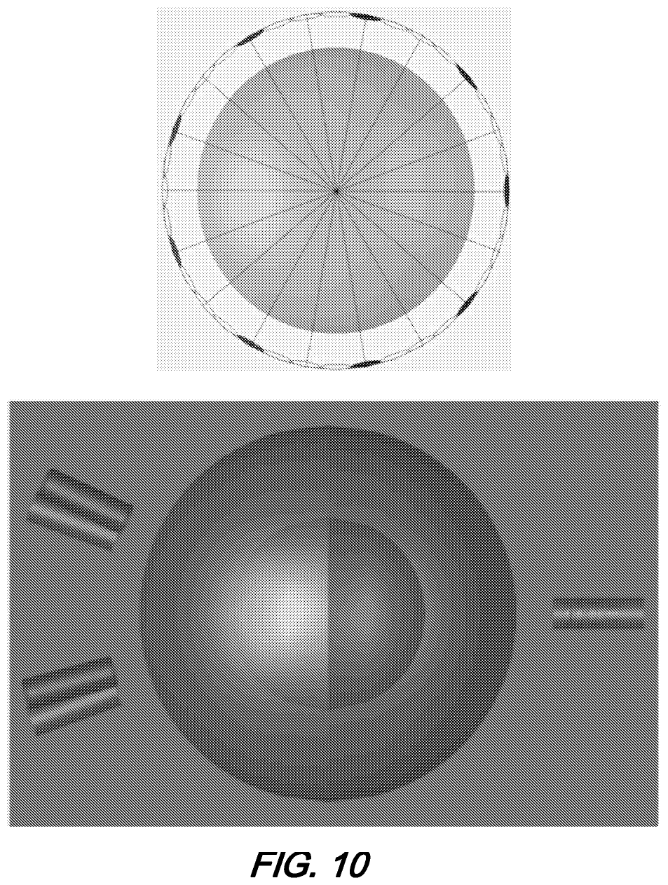

FIG. 10 shows illustrative microcameras and light window(s) of a 360° horizontal FOV imager according to aspects of the present disclosure. As illustrated in that figure, each microcamera is directed toward a respective clear tunnel each providing a reserved, circular view arranged horizontally, which advantageously provides a near obscuration free light passage. Detailed lens design data is shown in Table S3.

Finally, we now present a final illustrative example that is a omnidirectional camera which sees in all directions with uniform angular resolution. Previously in this disclosure, we estimated that the largest obscuration free angle for a MMS lens is less than 80° which implies a minimum of 4 MMS lenses are required for a full 4π spherical FoV coverage. Each camera of the four is positioned at one of the vertices of a regular tetrahedron and covers a solid angle slightly more than it steradian. The extra coverage is for overlapping.

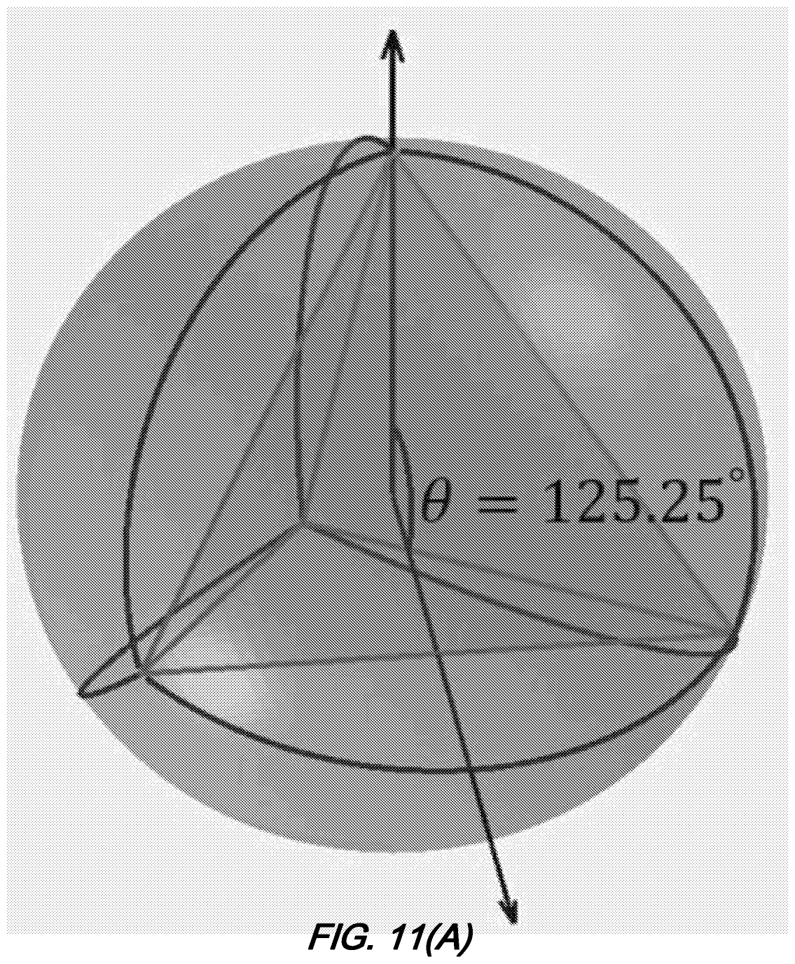

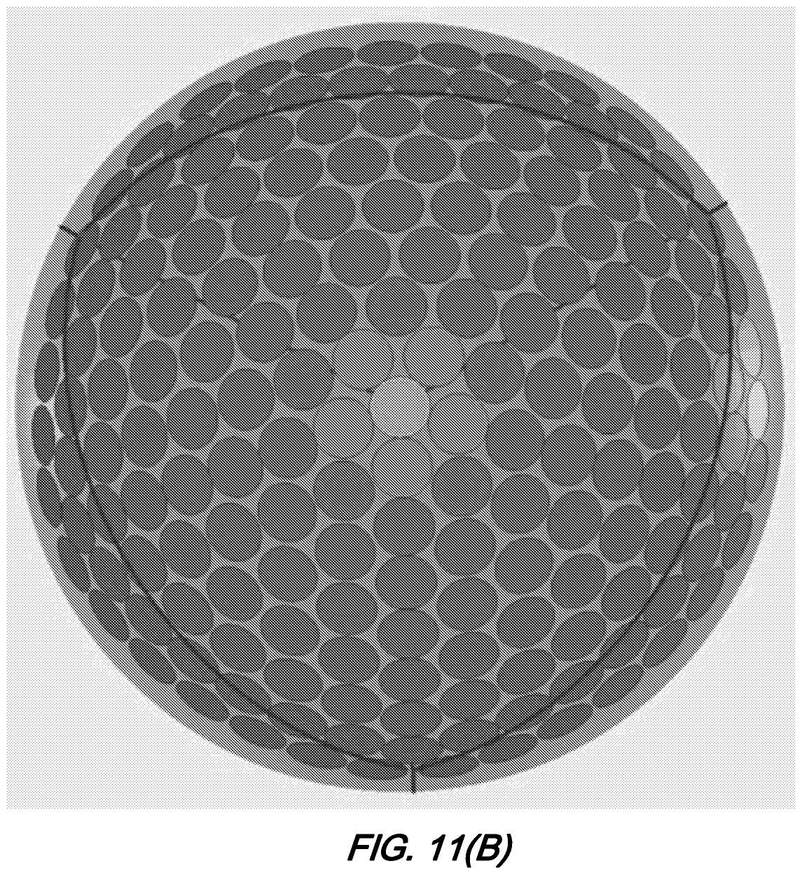

FIGS. 11(A) and 11(B) show illustrative tetrahedral geometry of full spherical MMS lens in which: FIG. 11(A) shows illustrative space segmentation with four MMS lenses with each one covering a quarter of the full sphere; and FIG. 11(B) showing illustratively close-packed microcameras on one of the four segments—according to an aspect of the present disclosure.

As illustratively shown in FIG. 11(A), the area projected by one of the triangular surfaces of a tetrahedron on its circumscribed sphere dictates the minimum covering area of each MMS lens. The largest field angle for this triangular spherical patch, as depicted in FIG. 11(A), is 125.26°. As shown in FIG. 10(B), we crop out a packing patch from a close-packed globe with the distorted icosahedron geodesic method.

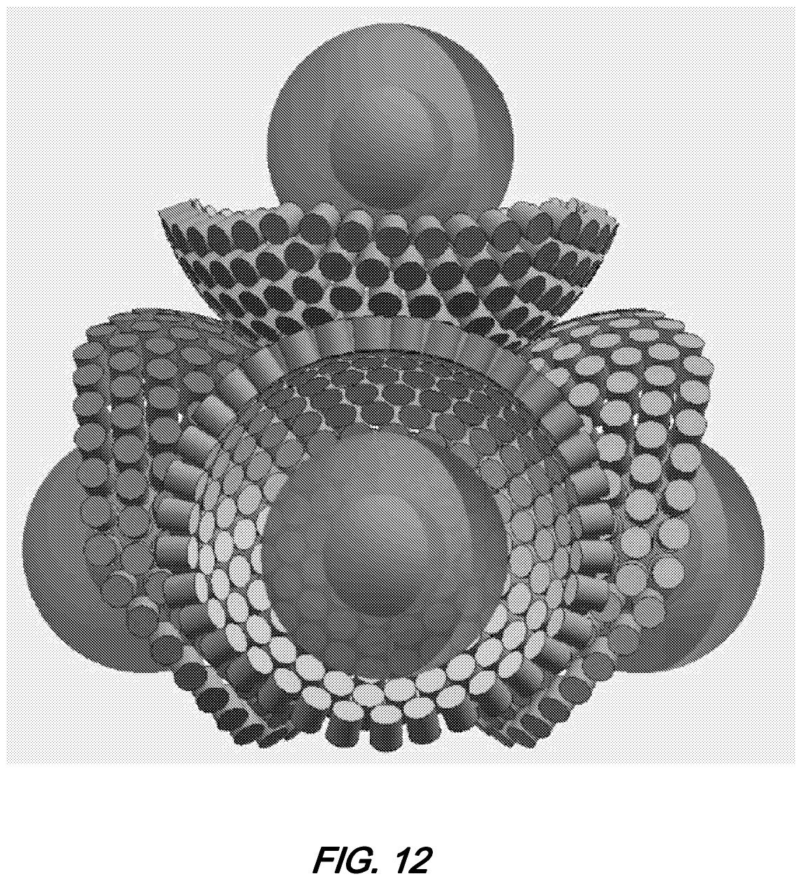

FIG. 12 shows illustrative layout view of a full spherical MMS lens according to aspects of the present disclosure. The geometry shown in that figure is a 4π full space camera bounded by a sphere having a radius of 74 mm. Advantageously, this illustrative imager has a potential of achieving a uniform angular resolution of ifov=83μ rad over complete space coverage employing the MMS lens design prescription used in our first example above and detailed in Table S1.

To provide a quantitative perception about all the design instances disclosed herein we provide Table 2 that describes field of view configurations, angular resolution, information capacity and physical size of each instance. This table helps verify the effectiveness of the MMS lens architecture in building high pixel count, versatile field of view configuration cameras with compactly small form factor.

At this point, those skilled in the art will readily appreciate that while the methods, techniques, and structures according to the present disclosure have been described with respect to particular implementations and/or embodiments, those skilled in the art will recognize that the disclosure is not so limited. Accordingly, the scope of the disclosure should only be limited by the claims appended hereto.

TABLE 2
Characteristics of MMS lens designs

| | | | Reso- | |
|---|---|---|---|---|
| | | | lution | |
| | | | Ele- | |
| | | | ments | Optics |
| | FoV | iFOV | (Mega- | Volume |
| System | (deg°) | (deg°) | pixels) | (Liters) |
| Rectangle | 4.5 × 10³ | 2.3 × 10⁻⁵ | 200 | 0.13 |
| | [90° × 50°] | [4.8 × 10⁻³° sq.] | | |
| 360 Ring | 1.2 × 10⁴ | 2.3 × 10⁻⁵ | 520 | 0.15 |
| | [360° × 33°] | [4.8 × 10⁻³° sq.] | | |
| Multifocal | 6.1 × 10² | 4.0 × 10⁻⁵ to 5.7 × 10⁻⁶ | 49 | 0.36 |
| | [61° × 10°] | [6.3 to | | |
| | | 2.4 × 10⁻³° sq.] | | |
| 360 | 9.7 × 10³ | 2.3 × 10⁻⁵ | 420 | 0.45 |
| Horizontal | [360° × 27°] | [4.8 × 10⁻³° sq.] | | |
| B2B | | | | |
| 360 | 9.7 × 10³ | 2.3 × 10⁻⁵ | 420 | 0.62 |
| Horizontal | [360° × 27°] | [4.8 × 10⁻³° sq.] | | |
| Stacks | | | | |
| Full | 1.3 × 10⁵ | 2.3 × 10⁻⁵ | 5600 | 1.70 |
| Spherical | [360° × 360°] | [4.8 × 10⁻³° sq.] | | |

TABLE S1
Optical prescription data for the rectangular, 360 ring and full
spherical FoV MMS lenses

| | | Rad of Curv. | Thick. | | Diam. |
|---|---|---|---|---|---|
| Surf. # | Comment | (mm) | (mm) | Material | (mm) |
| 1 | Ball lens | 21.110 | 9.775 | S-NBH8 | 23.111 |
| 2 | | 11.335 | 11.335 | F_SILICA | 16.760 |
| 3 | | Infinity | 11.335 | F_SILICA | 13.661 |
| 4 | | −11.335 | 9.775 | S-NBH8 | 9.480 |
| 5 | | −21.110 | 6.381 | | 7.502 |
| 6 | IR cut Stop | Infinity | 0.981 | | 3.326 |
| 7 | Microcamera | 4.675 | 7.286 | N-SK5 | 3.756 |
| 8 | | 3.613 | 1.837 | | 3.443 |
| 9 | | 7.211 | 1.479 | N-LAF21 | 4.230 |
| 10 | | −6.387 | 0.611 | N-SF57 | 4.207 |
| 11 | | −145.017 | 0.387 | | 4.201 |
| 12 | | 7.366 | 0.786 | N-5F57 | 4.176 |
| 13 | | 6.803 | 0.393 | | 3.953 |
| 14 | | 4.572 | 0.689 | N-SF6HT | 3.941 |
| 15 | | 3.247 | 1.905 | | 3.606 |
| 16 | Image | Infinity | — | | 3.988 |

TABLE S2
Optical prescription data for the multifocal MMS lens

| | | Rad of Curv. | Thick. | | Diam. |
|---|---|---|---|---|---|
| surf. # | Comment | (mm) | (mm) | Material | (mm) |
| 1 | Shared Ball lens | 32.554 | 14.378 | S-NBH8 | 65.200 |
| 2 | | 18.176 | 18.176 | F-SILICA | 36.400 |
| 3 | | Infinity | 18.176 | F-SILICA | 36.400 |
| 4 | | −18.176 | 14.378 | S-NBH8 | 36.400 |
| 5 | Channel 1 | −32.554 | 2.495 | | |
| | EFL = 15.00 mm | | | | |
| 6 | Stop | Infinity | 1.987 | | 2.505 |
| 7 | | −3.681 | 1.184 | ZF4 | 2.973 |
| 8 | | −4.932 | 0.500 | | 3.587 |
| 9 | | −18.911 | 2.105 | H-LAF10LA | 3.846 |
| 10 | | −7.344 | 0.485 | | 4.378 |
| 11 | | 6.473 | 1.901 | H-K9L | 4.401 |
| 17 | | −4.343 | 0.780 | H-ZF1 | 4.179 |
| 13 | | −13.640 | 0.461 | | 4.042 |
| 14 | | 16.302 | 1.839 | H-ZF52A | 3.756 |
| 15 | | 5.959 | 3.954 | | 3.133 |
| 16 | | Infinity | — | | 2.627 |
| 5 | Channel 2 | −32.554 | 3.000 | | 65.200 |
| | EFL = 16.38 mm | | | | |
| 6 | Stop | Infinity | 1.926 | | 2.696 |
| 7 | | −3.494 | 1.668 | ZF4 | 3.129 |
| 8 | | −4.510 | 0.583 | | 4.028 |
| 9 | | −293.457 | 1.215 | H-LAF10LA | 4.322 |
| 10 | | −11.618 | 0 498 | | 4.484 |
| 11 | | 8.099 | 1.695 | H-K9L | 4.464 |
| 12 | | −4.328 | 0.742 | H-ZF1 | 4.300 |
| 13 | | −11.470 | 0.357 | | 4.196 |
| 14 | | 28.353 | 2.769 | H-ZF52A | 3.945 |
| 15 | | 5.964 | 3.892 | | 3.122 |
| 16 | | Infinity | — | | 2.874 |
| 5 | Channel 3 | −37.554 | 6.191 | | 65.200 |
| | EFL = 18.48 mm | | | | |
| 6 | Stop | Infinity | 1.983 | | 3.015 |
| 7 | | −3.238 | 1.024 | ZF4 | 3.421 |
| 8 | | −4.042 | 0.705 | | 4.061 |
| 9 | | −25.096 | 1.266 | H-LAF10LA | 4.434 |
| 10 | | −7.961 | 0.492 | | 4.695 |
| 11 | | 10.680 | 1.822 | H-K9L | 4.671 |
| 12 | | −4.697 | 0.797 | H-ZF1 | 4.511 |
| 13 | | −14.615 | 0.473 | | 4.438 |
| 14 | | 11.317 | 2.922 | H-ZF52A | 4.184 |
| 15 | | 4.339 | 3.992 | | 3.165 |
| 16 | | Infinity | — | | 3.269 |
| 5 | Channel 4 | −32.554 | 10.000 | | 65.200 |
| | EFL = 21.71 mm | | | | |
| 6 | Stop | Infinity | 2.000 | | 2.852 |
| 7 | | −2.889 | 0.800 | ZF4 | 3.355 |
| 8 | | −3.752 | 0.500 | | 3.953 |
| 9 | | −20.792 | 0.852 | H-LAF10LA | 4.386 |
| 10 | | −5.784 | 1.045 | | 4.559 |
| 11 | | 11.226 | 1.294 | H-K9L | 4.484 |
| 12 | | −4.551 | 1.812 | H-ZF1 | 4.402 |
| 13 | | −57.227 | 1.171 | | 4.259 |
| 14 | | 6.444 | 1.569 | H-ZF52A | 4.031 |
| 15 | | 3.665 | 2.998 | | 3.404 |
| 16 | | Infinity | — | | 3.842 |
| 5 | Channel 5 | −32.554 | 10.000 | | 65.200 |
| | EFL = 27.00 mm | | | | |
| 6 | Stop | Infinity | 1.997 | | 3.753 |
| 7 | | −4.206 | 1.070 | ZF4 | 4.177 |
| 8 | | −4.856 | 1.856 | | 4.807 |
| 9 | | −109.317 | 1.279 | H-LAF10LA | 5.536 |
| 10 | | −13.201 | 0.713 | | 5.723 |
| 11 | | 14.713 | 1.957 | H-K9L | 5.707 |
| 12 | | −6.382 | 1.055 | H-ZF1 | 5.561 |
| 13 | | −30.441 | 0.500 | | 5.480 |
| 14 | | 13.416 | 3.754 | H-ZF52A | 5.299 |
| 15 | | 5.245 | 3.996 | | 4.150 |
| 16 | | Infinity | — | | 4.779 |
| 5 | Channel 6 | −32.554 | 10.000 | | 65.200 |
| | EFL = 36.73 mm | | | | |
| 6 | Stop | Infinity | 1.993 | | 4.567 |
| 7 | | −8.946 | 0.960 | ZF4 | 5.051 |
| 8 | | −11.706 | 0.493 | | 5.471 |
| 9 | | −53.236 | 1.278 | H-K9L | 5.749 |
| 10 | | −12.718 | 6.759 | | 6.029 |
| 11 | | 38.788 | 2.002 | H-ZLAF55C | 7.316 |
| 12 | | −485.135 | 0.541 | | 7.332 |
| 13 | | 9.271 | 1.787 | H-LAK1 | 7.340 |
| 14 | | −210.496 | 0.502 | | 7.010 |
| 15 | | −20.822 | 0.906 | H-K9L | 6.865 |
| 16 | | −28.049 | 0.499 | | 6.613 |
| 17 | | 68.234 | 0.796 | H-ZF52A | 6.210 |
| 18 | | 6.042 | 2.488 | | 5.742 |
| 19 | | Infinity | — | | 6.286 |
| 5 | Channel 7 | −32.554 | 10.000 | | 65.200 |
| | EFL = 40 mm | | | | |
| 6 | Stop | Infinity | 1.996 | | 4.592 |
| 7 | | −12.217 | 1.918 | ZF4 | 5.012 |
| 8 | | −15.731 | 0.500 | | 5.622 |
| 9 | | −27.583 | 1.154 | H-KL | 5.792 |
| 10 | | −15.102 | 7.325 | | 6.050 |
| 11 | | 37.942 | 1.468 | H-ZLAF55C | 7.459 |
| 12 | | −128.962 | 0.500 | | 7.467 |
| 13 | | 8.448 | 1.778 | H-LAK1 | 7.421 |
| 14 | | 79.899 | 0.496 | | 7.026 |
| 15 | | −35.051 | 0.847 | H-K9L | 6.873 |
| 16 | | −289.197 | 0.493 | | 6.554 |
| 17 | | 20.475 | 0.798 | H-ZF52A | 6.177 |
| 18 | | 5.565 | 3.986 | | 5.628 |
| 19 | | Infinity | — | | 6.271 |

TABLE S3
Design data for 360 horizontal FoV MMS lens

| | | Rad of Curv. | Thick. | | Diam. |
|---|---|---|---|---|---|
| Surf. # | Comment | (mm) | (mm) | Material | (mm) |
| 1 | Ball lens | 30.217 | 14.661 | S-NBH8 | 23.111 |
| 2 | | 15.556 | 15.556 | F-SILICA | 16.760 |
| 3 | | Infinity | 15.556 | F-SILICA | 13.661 |
| 4 | | −15.556 | 14.661 | S-NBH8 | 9.480 |
| 5 | | −30.217 | 5.855 | | 7.502 |
| 6 | IR cut Stop | Infinity | 2.012 | | 1.229 |
| 7 | Microcamera | −3.639 | 1.080 | N-SK5 | 3.086 |
| 8 | | −4.288 | 0.500 | | 3.458 |
| 9 | | 24.379 | 1.257 | N-LAF21 | 3.434 |
| 10 | | −16.968 | 0.568 | N-SF57 | 3.352 |
| 11 | | 9.795 | 1.842 | | 3.126 |
| 12 | | −5.173 | 0.815 | N-SF57 | 2.677 |
| 13 | | −20.882 | 0.517 | | 2.473 |
| 14 | | 12.233 | 1.962 | N-SF6HT | 2.216 |
| 15 | | 3.957 | 4.003 | | 1.677 |
| 16 | Image | Infinity | — | | 3.018 |

1. A monocentric multiscale optical system (MMS) CHARACTERIZED BY:
a Galilean MMS lens configuration generated by a distorted icosahedron geodesic method, said configuration including a plurality of individual cameras positioned in a top-hemispherical arrangement producing a ring-shaped field of view (FoV).

2. A monocentric multiscale optical system (MMS) CHARACTERIZED BY:
a Galilean MMS lens configuration including a plurality of imaging channels, each one of the plurality of imaging channels exhibiting an overlap of a portion of adjacent imaging channels, each one of the individual channels exhibiting a different focal length from one another.

3. A monocentric multiscale optical system (MMS) CHARACTERIZED BY:
at least three MMS lens configurations positioned along a common plane in a back-to-back arrangement such that a 360 degree horizontal field of view along that plane is produced.

4. The monocentric multiscale optical system of claim 3 FURTHER CHARACTERIZED BY:
each of the individual MMS lens' exhibit a horizontal field of view (FoV) that is larger than 120 degrees.

5. A monocentric multiscale optical system (MMS) CHARACTERIZED BY:
at least three MMS lens configurations vertically arranged along a common central axis, each individual one of the MMS lens configurations configured to provide a portion of a 360 horizontal field of view.
